(19) United States
(12) Patent Application Publication
(10) Pub. No.: US 2006/0251769 A1
(43) Pub. Date: Nov. 9, 2006

(54) Comestible product dispenser for displaying comestible products and related information and method of using same

(76) Inventor: Jonathan Edward Rathbone, Chicago, IL (US)

Correspondence Address: Bell, Boyd & Lloyd LLC, P.O. Box 1135, Chicago, IL, 60690-1135, US

(21) Appl. No.: 11/125,934

(22) Filed: May 9, 2005

(51) Int. Cl. A23B 7/148

(52) U.S. Cl. 426/106

(57) ABSTRACT

A first product dispenser is provided and includes a housing defining an interior, where the housing includes a divider and at least one display area. The divider is adapted to separate a plurality of comestible products. The product dispenser includes a door hingedly connected to the housing to allow access to the interior of the housing. The divider is so constructed and arranged to separate the comestible products and display at least a portion of the comestible products and the display area on a same side of the housing to a consumer.

### BACKGROUND

The present invention relates generally to packaging. More particularly, the present invention relates to packaging or dispensers for storing and dispensing comestible products.

The packaging for comestible products is very important to the look, marketing and storage of the product. Very often, in addition to text on the packaging, the packaging also attempts to visually convey a message about the type of product, the taste of the product or the purpose of the product. For example, packages for cinnamon or cherry tasting products are often red, grape tasting product packaging is often purple, etc. Once the consumer has identified a desired brand, the consumer can typically choose a product based solely on the color of the packaging.

In marketing the product, packaging can convey other information besides taste whereby the consumer can thereby associate the product with its effect by simply viewing the packaging.

There are also practical facets to packaging comestible products, namely, keeping the products from being damaged during shipping, keeping the products fresh, and in certain instances providing a reusable package. Some comestible products do not require that the packaging be robust, sturdy or reusable.

Other comestible products are packaged in pieces and may or may not be provided in a reusable package, as desired by the manufacturer. If it is felt that only a portion of the products may be consumed in one sitting, the manufacturer may wish to provide a box having a hingedly connected lid.

With certain comestible products, the consumer tears open a package and removes a product or piece of the product. One problem with this type of packaging is that the remaining product tends to fall out of the package after the consumer removes one or more pieces from the package. Another problem with these packages is that it becomes difficult, especially with a newly opened package, to remove a piece without ripping open a significant portion of the package.

Attempting to provide a package that holds the product even after the removal of one or more pieces of the product can make removing the comestible product more difficult. Tightly packing the product may aid in holding the product at the expense of gaining access to the product.

### SUMMARY

The present invention provides an apparatus and method for dispensing products, such as products that are individually unpackaged. The products in one embodiment are comestible products. The teachings of the present invention, however, are not dependent upon the products being any particular type as long as the products can fit within the product dispenser described herein. The dispenser herein, regardless of what product is being dispensed, is configured to be highly functional and to have an aesthetic element.

It is believed that users of these products, and in particular younger users, find certain features desirable and undesirable in the packaging of products consumed on a daily basis, such as comestible products. Specifically, it is believed that consumers desire a compact shape for easy, everyday storage. It is an added benefit to the manufacturer if the shape is also innovative and/or sleek looking. Such a shape gains customer attention. Furthermore, it is desirable to have a dispenser that is intuitive and easy to determine how to use. Still further, consumers, especially young consumers, desire the dispenser to be quiet and to not require too much manipulation, so that the products can be dispensed in an easy and discrete manner.

Moreover, control over product dispensing is important. That is, consumers want to be able dispense only a desired amount of product. To that end, especially in the case of individually unpackaged products, it is desirable that the products do not stick or clump together.

In one embodiment, a product dispenser is provided including a housing defining an interior, where the housing includes a divider and at least one display area. The divider is adapted to separate a plurality of comestible products. The product dispenser includes a door hingedly connected to the housing to allow access to the interior of the housing. The divider is so constructed and arranged to separate the comestible products and display at least a portion of the comestible products and the display area on a same side of the housing to a consumer.

In an embodiment, the housing is substantially transparent.

In an embodiment, the housing includes at least one opaque portion.

In an embodiment, the display area includes information selected from the group consisting of: product name, product information, marketing information and promotion information.

In an embodiment, the divider is an S-shaped divider.

In an embodiment, the housing includes a plurality of display areas.

Another embodiment of the product dispenser is provided and includes a housing including a divider, where the divider is adapted to display a plurality of comestible products. The product dispenser includes at least one display area connected to the housing.

In an embodiment, the plurality of comestible products are adjacent to each display area.

In an embodiment, the housing is made with a substantially transparent material.

In an embodiment, the housing includes at least one opaque portion.

In an embodiment, the display area includes information selected from the group consisting of: product name, product information, marketing information and promotion information.

In a further embodiment, a method for dispensing comestible products is provided. The method includes displaying a plurality of comestible products on a divider inside a housing and displaying information regarding the comestible products adjacent to the displayed comestible products, wherein at least a portion of the comestible products and the information is visible to a consumer on a same side of the housing.

In an embodiment, the method includes attaching at least one door to the housing, where the door enables a person to insert additional comestible product into the housing.

In an embodiment, the housing is substantially transparent.

In an embodiment, the method includes selecting the information from the group consisting of: product name, product information, marketing information and promotion information.

In an embodiment, the method includes providing the housing with at least one opaque portion.

It is therefore an advantage of the present invention to provide a product dispenser that displays a product in the dispenser and gains customer attention.

It is another advantage of the present invention to provide a product dispenser for dispensing individually unwrapped products, where the products do not stick to one another or clump.

It is a further advantage of the present invention to provide a product dispenser that is compact and easily stored.

Moreover, it is an advantage of the present invention to provide a product dispenser that is quiet both when being transported and when dispensing comestible product.

Still further, it is an advantage of the present invention to provide a product dispenser that is controllable to dispense only a desired amount of product.

Yet further, it is an advantage of the present invention to provide a product dispenser that dispenses products via gravity alone without agitation.

Additional features and advantages of the present invention are described in, and will be apparent from, the following Detailed Description and the figures.

### BRIEF DESCRIPTION OF THE FIGURES

FIG. 1 illustrates a perspective view of one embodiment of the product dispenser of the present invention.

FIG. 2 illustrates a front view of the embodiment of the product dispenser of FIG. 1.

FIG. 3 illustrates a rear view of the embodiment of the product dispenser of FIG. 1.

FIG. 4 illustrates a right side view of the embodiment of the product dispenser of FIG. 1.

FIG. 5 illustrates a left side view of the embodiment of the product dispenser of FIG. 1.

FIG. 6 illustrates an exploded perspective view of the dispenser of FIG. 1, where the door of the housing is in the open position.

### DETAILED DESCRIPTION

The present invention provides a comestible product package and dispenser. In the embodiment described herein, the comestible products are illustrated as tablets of products, such as generally oval-shaped pieces of comestible product. The products to be dispensed from the dispensers discussed herein can have any suitable types of shapes, such as a block shape, a flat stick shape, a pillow-shape, a round shape, a rectangular shape, a triangular shape and any combination of same.

The embodiment described below is generally made of a plastic material. The present invention expressly includes the embodiment being made of any material such as any suitable paper, cardboard, paperboard material, foil, plastic, composite or other suitable material. Furthermore, while the package and dispenser discussed herein is sized to be transported readily by a person (for example, in a person's pocket, purse, backpack, or the like), the embodiment is expressly not limited to any particular size and shape.

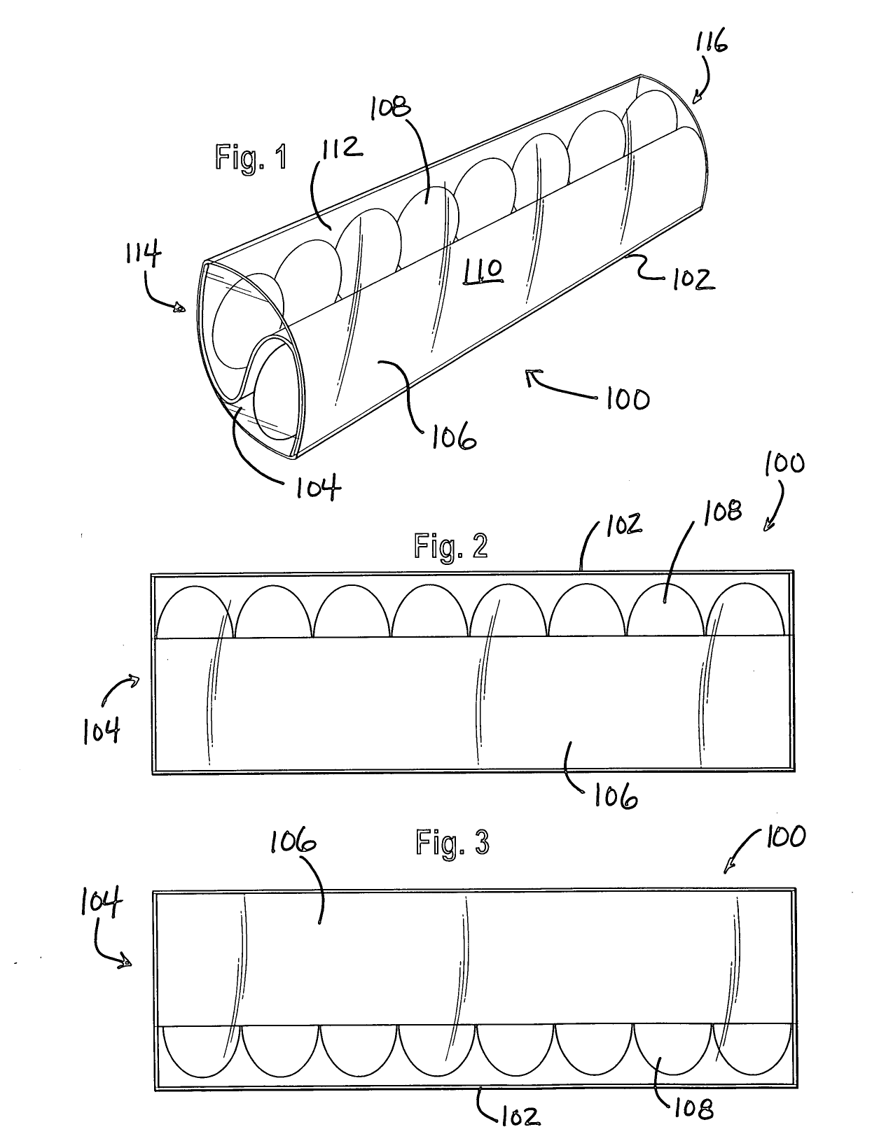

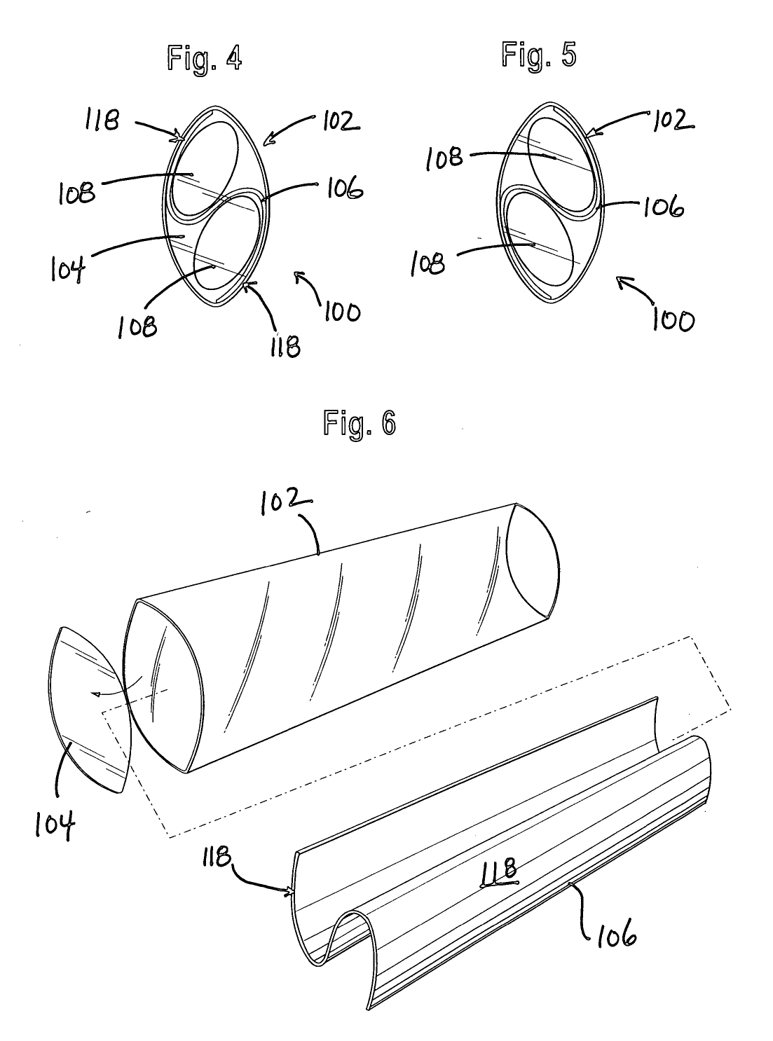

Referring now to the drawings, and in particular to FIGS. 1 to 6, one embodiment of a comestible product package or dispenser is illustrated as dispenser 100. In one embodiment, the dispenser 100 is a refillable dispenser. In another embodiment, the dispenser 100 is non-refillable and is discarded after dispensing one or more pieces of product. The product dispenser 100 includes a first member, body or housing 102 and a second member, product support or divider 102. The housing 102 is sized to receive the divider 106, where the divider is slideably inserted into the interior of the housing 102. The divider 106 separates, supports and displays a designated or desired number of the comestible products stored in the housing 102.

As illustrated in FIGS. 1 and 6, the housing is generally a four-sided structure having a front wall or front surface 110, side walls or ends 114 and 116 and a rear wall or rear surface 112. The walls of the housing 102 form a receptacle, interior or compartment for receiving the divider 106 and the product 108. In the illustrated embodiment, the housing 102 is integrally formed as one piece or one part. In another embodiment, the walls of the housing 102 are separately manufactured and connected together to form the housing. In the illustrated embodiment, the housing 102 has a generally oval or oblong cylindrical shape. It should be appreciated that the housing 102 may be any suitable size or shape. As illustrated, the right wall or right end 114 of the housing defines an opening which enables comestible product to be dispensed or otherwise removed from the dispenser 100.

The divider 106 is generally manufactured form cardboard or paper board or any other suitable material and includes an S-shape to support and display the product in the product dispenser as shown in FIG. 1. The S-shape of the divider enables the divider to at least partially display the product 108 on each side of the product dispenser. This shape also provides elongated display areas or surfaces 118 which at least partially conform to the shape of the housing 102. The elongated surfaces 118 enable a user such as a manufacturer to place a label, text, pictures or other information describing the product on one or both of the elongated surfaces so that the information is clearly visible by a consumer. It should be appreciated that the information may be adhered to, printed on, written, etc. on the surfaces of the divider. Alternatively, the information is adhered to, printed on, written on or the like on the front surface 110 and/or rear surface 112 of the housing 102 adjacent to the elongated surfaces 118 of the divider. The shape and position of the divider 106 therefore allows a consumer to clearly see the information describing the product as well as the product itself from either the front surface 110 or the rear surface of 112 of the product dispenser. It should be appreciated that the information describing or related to the product may be placed on any suitable surface or surfaces of the divider 106 and/or the housing 102. It should also be appreciated that the divider 106 may be any suitable size or shape to display the product as described above.

As described above, the housing 102 is generally a four-sided structure including a top wall, side walls, and a rear wall. The walls of the housing 102 form or define a compartment, interior or receptacle for receiving one or more pieces of the comestible product 108. In the illustrated embodiment, at least one lid, door or cover 104 is hingedly connected to the right end 114 of the housing 102 and pivots toward and away from the housing. In the closed position, the cover 104 holds or maintains the comestible product 108 inside the housing 102. In the open position, the cover 104 enables a person to fill or re-fill the interior of the housing with comestible product. It should be appreciated that any suitable lid, door or cover or other device may be employed to cover and seal the opening at one or both ends of the housing 102. In another embodiment, a separate removable lid or cover (not shown) is connected to at least one end of the housing 102 to maintain the product in the housing. In an embodiment, the cover 104 includes at least one securing device or snap lock device (not shown) which holds the cover in place when the cover is in the closed position shown in FIG. 1. It should be appreciated that any suitable securing device or devices may be employed to secure the cover or covers in the closed position.

In the illustrated embodiment, the divider 106 is a separate piece or part which is inserted into the interior of the housing 102. In another embodiment, the divider 106 is integrally formed with the housing 102 to form the product dispenser 100.

In an embodiment, at least a portion of the housing 102 includes a transparent material that enables a consumer or user to see into the product dispenser. It should be appreciated that the material may be substantially transparent, transparent, translucent, substantially translucent, or any combination of these materials or other suitable materials. In another embodiment, at least a portion of the housing 102 includes an opaque or substantially opaque material. It should be appreciated that the housing 102 may be made using any suitable material or combination of materials.

In operation, a user such as a consumer, holds the housing 102 of the product dispenser in one hand and moves the cover 104 from the closed position shown in FIG. 1 to the open position shown in FIG. 6. The user tilts or otherwise positions the housing 102 so that one or more of the products 108 are dispensed from the housing. After dispensing the product, the user moves the cover 104 from the open position to the closed position to maintain the product in the housing 102.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A comestible product dispenser comprising:
a housing defining an interior, said housing including a divider and at least one display area, said divider adapted to separate a plurality of comestible products; and
a door hingedly connected to the housing to allow access to the interior of the housing,
wherein the divider is so constructed and arranged to separate the comestible products and display at least a portion of the comestible products and the display area to a consumer.

2. The comestible product dispenser of claim 1, wherein the housing is substantially transparent.

3. The comestible product dispenser of claim 1, wherein the housing includes at least one opaque portion.

4. The comestible product dispenser of claim 1, wherein the display area includes information selected from the group consisting of: product name, product information, marketing information and promotion information.

5. The comestible product dispenser of claim 1, wherein the divider is an S-shaped divider.

6. The comestible product dispenser of claim 1, wherein the housing includes a plurality of display areas.

7. A comestible product dispenser comprising:
a housing including a divider, said divider adapted to display a plurality of comestible products; and
at least one display area connected to the housing.

8. The comestible product dispenser of claim 7, wherein the plurality of comestible products are adjacent to each display area.

9. The comestible product dispenser of claim 7, wherein the housing is made with a substantially transparent material.

10. The comestible product dispenser of claim 7, wherein the housing includes at least one opaque portion.

11. The comestible product dispenser of claim 7, wherein the display area includes information selected from the group consisting of: product name, product information, marketing information and promotion information.

12. A method for dispensing comestible products comprising:
displaying a plurality of comestible products on a divider inside a housing; and
displaying information regarding the comestible products adjacent to the displayed comestible products, wherein at least a portion of the comestible products and the information is visible to a consumer on a same side of the housing.

13. The method of claim 12, which includes attaching at least one door to the housing, the door enabling a person to insert additional comestible product into the housing.

14. The method of claim 12, wherein the housing is substantially transparent.

15. The method of claim 12, which includes selecting the information from the group consisting of: product name, product information, marketing information and promotion information.

16. The method of claim 12, wherein the housing includes at least one opaque portion.
